(19) United States
(12) Patent Application Publication
(10) Pub. No.: US 2007/0197799 A1
(43) Pub. Date: Aug. 23, 2007

(54) Novel bisphosphane catalysts

(75) Inventors: Jens Holz, Kessin (DE); Armin Borner, Rostock (DE); Juan J. Almena Perea, Hanau (DE); Renat Kadyrov, Frankfurt (DE); Axel Monsees, Frankfurt (DE); Thomas Riermeier, Nidderau-Ostheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/573,275

(22) PCT Filed: Sep. 24, 2005
(86) PCT No.: PCT/EP05/10366

§ 371 Date: Feb. 6, 2007

(30) Foreign Application Priority Data
Oct. 22, 2004 (DE) 10 2004 051 456.9

(51) Int. Cl. C07F 9/02

(52) U.S. Cl. 549/3; 549/6; 568/9

(57) ABSTRACT

In the present application protection is sought for compounds of the general formula (I) as ligands for reactions catalysed by transition metals. The preparation thereof and use thereof, in particular for the preparation of β-amino acids, is also discussed.

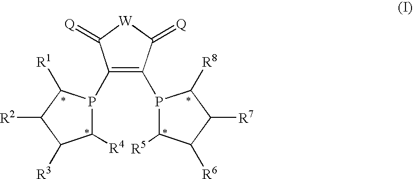

The present invention relates to novel bisphosphane catalysts. In particular, the invention relates to catalysts of the general formula (I).

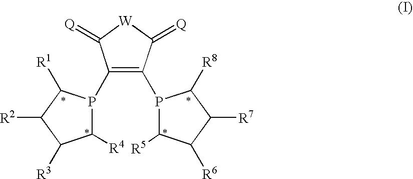

Enantiomerically enriched chiral ligands are employed in asymmetric synthesis and asymmetric catalysis. It is essentially a matter here of optimum matching of the electronic and the stereochemical properties of the ligands to the particular catalysis problem. An important aspect of the success of these classes of compounds is attributed to the creation of a particularly asymmetric environment around the metal centre by these ligand systems. In order to use such an environment for an effective transfer of the chirality, it is advantageous to control the flexibility of the ligand system as inherent limitation of the asymmetric induction.

Within the substance class of phosphorus-containing ligands, cyclic phosphines, in particular the phospholanes, have achieved particular importance. Bidentate chiral phospholanes are, for example, the DuPhos and BPE ligands employed in asymmetric catalysis. In the ideal case, however, a diversely modifiable chiral ligand base matrix which can be varied within wide limits in respect of its steric and electronic properties is available.

WO03/084971 discloses catalyst systems with which, in particular, exceptionally positive results can be achieved in hydrogenation reactions. Above all, the catalyst types derived from maleic anhydride and cyclic maleimide evidently create, in their characteristic as chiral ligands, such a good environment around the central atom of the complex employed that for some hydrogenation reactions these complexes are superior to the best hydrogenation catalysts currently known. Nevertheless, in some uses they lack the necessary stability due to the relatively active groups in the five-ring backbone.

It is therefore the object of this invention to provide a ligand skeleton which has a stability which is analogous to that of the known phosphane ligands but is moreover increased compared to this, and can be varied within wide limits in respect of electronic and steric circumstances and has comparably good catalytic properties. In particular, the invention is based on the object of providing novel bidentate and chiral phosphane ligand systems for catalytic purposes, which are easy to prepare in a high enantiomer purity.

This object is achieved according to the claims. Claim 1 relates to novel enantiomerically enriched organophosphorus ligands. The dependent subclaims 2 and 3 relate to preferred embodiments. Claims 4 and 5 are directed at advantageous complexes which can serve as catalysts. Claim 6 relates to a process according to the invention for the preparation of the novel bisphospholanes. Claims 7 to 15 are directed at preferred uses of these complexes.

As a result of providing enantiomerically enriched bidentate organophosphorus ligands of the general formula (I) 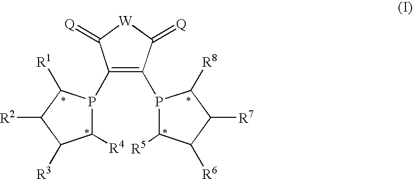
wherein
* denotes a stereogenic centre,
R¹, R⁴, R⁵, R⁸ independently of one another denote
(C₁-C₈)-alkyl, (C₁-C₈)-alkoxy, HO—(C₁-C₈)-alkyl,
(C₂-C₈)-alkoxyalkyl, (C₆-C₁₈)-aryl, (C₇-C₁₉)-aralkyl,
(C₃-C₁₈)-heteroaryl, (C₄-C₁₉)-heteroaralkyl,
(C₁-C₈)-alkyl-(C₆-C₁₈)-aryl,
(C₁-C₈)-alkyl-(C₃-C₁₈)-heteroaryl, (C₃-C₈)-cycloalkyl,
(C₁-C₈)-alkyl-(C₃-C₈)-cycloalkyl or
(C₃-C₈)-cycloalkyl-(C₁-C₈)-alkyl,
R², R³, R⁶, R⁷ independently of one another denote R¹ or H, wherein in each case adjacent radicals R¹ to R⁸ can be bonded to one another by a (C₃-C₅)-alkylene bridge, which can contain one or more double bonds or heteroatoms, such as N, O, P or S,
Q can be O, NR² or S
W═S, CR²R³ or C═X, where X is chosen from the group consisting of CR²R³, O and NR², the object is achieved in a surprising and nevertheless relatively simple nature and manner. The ligand systems disclosed here are decidedly stable compared with the corresponding particularly good analogous compounds of the prior art, and for this reason it is also possible to use these ligands under more extreme reaction conditions. Furthermore, in some respects they show either a faster and/or more selective reactivity compared with the systems of the prior art.

In respect of ligand systems which are preferably to be employed, those which are characterized in that they contain as radicals R², R³, R⁶, R⁷ (C₁-C₈)-alkoxy, (C₂-C₈)-alkoxyalkyl or H are possible. A ligand in which R¹, R⁴, R⁸, R⁵ are (C₁-C₈)-alkyl, in particular methyl or ethyl, (C₆-C₁₈)-aryl, in particular phenyl, (C₁-C₈)-alkoxy or (C₂-C₈)-alkoxyalkyl is very particularly preferred. In these cases R², R³, R⁶, R⁷ are extremely preferably H. Ligands of the formula (I) according to the invention which have an enantiomer enrichment of >90%, preferably >95%, are furthermore preferred.

In the ligand systems according to the invention, all the C atoms in the phospholane ring can optionally build up a stereogenic centre.

The invention also provides complexes which contain the ligands according to the invention and at least one transition metal.

Suitable complexes, in particular of the general formula (V), contain ligands of the formula (I) according to the invention
[MₓP_{y}L_{z}S_{q}]Aᵣ (V)
wherein, in the general formula (V), M represents a metal centre, preferably a transition metal centre, L represents identical or different coordinating organic or inorganic ligands and P represents bidentate organophosphorus ligands of the formula (I) according to the invention, S represents coordinating solvent molecules and A represents equivalents of non-coordinating anions, and wherein x and y correspond to integers greater than or equal to 1 and z, q and r correspond to integers greater than or equal to 0.

The upper limit of the sum of y+z+q is determined by the coordination centres available on the metal centres, where not all coordination sites have to be occupied. Complex compounds having an octahedral, pseudo-octahedral, tetrahedral, pseudo-tetrahedral or tetragonal-planar coordination sphere, which can also be distorted, around the particular transition metal centre are preferred. The sum of y+z+q in such complex compounds is less than or equal to 6.

The complex compounds according to the invention contain at least one metal atom or ion, preferably a transition metal atom or ion, in particular of palladium, platinum, rhodium, ruthenium, osmium, iridium, cobalt, nickel or copper, in any catalytically relevant oxidation level.

Preferred complex compounds are those having less than four metal centres, particularly preferably those having one or two metal centres. In this context, the metal centres can be occupied by different metal atoms and/or ions.

Preferred ligands L of such complex compounds are halide, in particular Cl, Br and I, diene, in particular cyclooctadiene and norbornadiene, olefin, in particular ethylene and cyclooctene, acetato, trifluoroacetato, acetylacetonato, allyl, methallyl, alkyl, in particular methyl and ethyl, nitrile, in particular acetonitrile and benzonitrile, as well as carbonyl and hydrido ligands.

Preferred coordinating solvents S are amines, in particular triethylamine, alcohols, in particular methanol, ethanol and i-propanol, and aromatics, in particular benzene and cumene.

Preferred non-coordinating anions A are trifluoroacetate, trifluoromethanesulfonate, BF₄, ClO₄, PF₆, SbF₆ and BAr₄, wherein Ar can be (C₆-C₁₈)-aryl.

In this context, the individual complex compounds can contain different molecules, atoms or ions of the individual constituents M, P, L, S and A.

Compounds which are preferred among the complex compounds of ionic structure are those of the type [RhP(diene)]⁺A⁻, wherein P represents a ligand of the formula (I) according to the invention.

The invention also provides a process for the preparation of the compounds of the general formula (I). This preferably starts from a compound of the general formula (II) 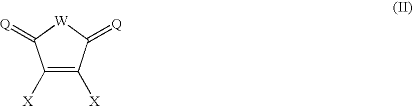
wherein
Q, W can assume the abovementioned meaning
X represents a nucleofugic leaving group, which is reacted with at least 2 equivalents of a compound of the general formula (III) 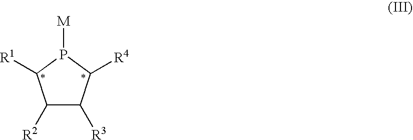
in which R¹ to R⁴ can assume the meaning given above and M can be a metal of the group consisting of Li, Na, K, Mg and Ca or represents a trimethylsilyl group In respect of the preparation of the starting compounds and the conditions of the reactions, reference is made to the following literature (DE10353831; WO03/084971; EP592552; U.S. Pat. No. 5,329,015).

A possible variant of the preparation of the ligands and complexes is shown in the following equation: 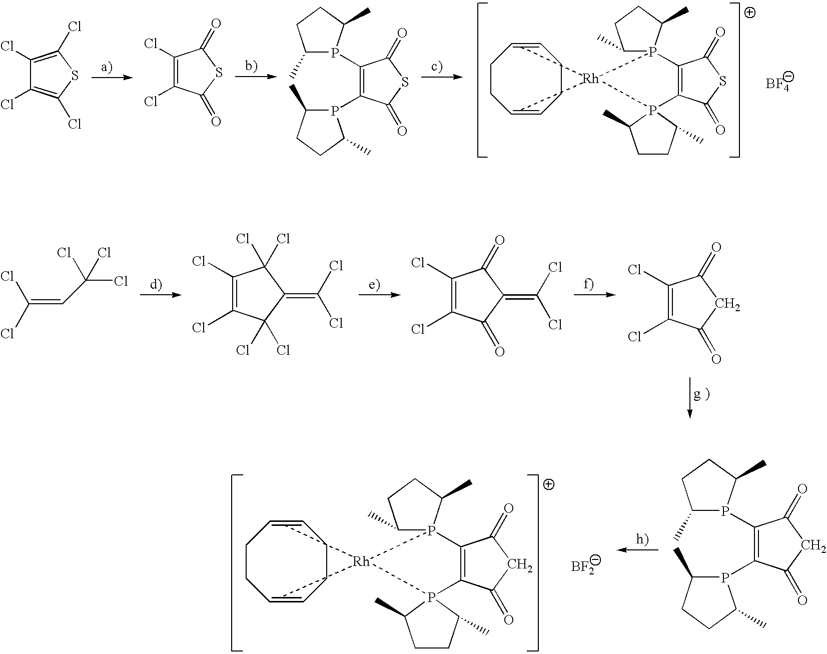
a) HNO₃ (98%), from O. Scherer, F. Kluge Chem. Ber. (1966), 1973-1983; b) and c) in accordance with standard instructions; d) CuCl₂, 2.5 h, reflux, 80% strength ethanol, from H. J. Pins Rec. Trav. Chim. 68 (1949) 419-425; e) H₂SO₄ (conc.), 2 h, 100° C., from McBee J. Am. Chem. Soc. 77 (1955) 4379-4380; f) EtOH, 1.5 h, reflux, from McBee J. Am. Chem. Soc. 78 (1956) 491-493; g) and h) in accordance with standard instructions.

The preparation of the metal-ligand complex compounds according to the invention just shown can be carried out in situ by reaction of a metal salt or a corresponding pre-complex with the ligands of the general formula (I). A metal-ligand complex compound can moreover be obtained by reaction of a metal salt or a corresponding pre-complex with the ligands of the general formula (I) and subsequent isolation.

Examples of the metal salts are metal chlorides, bromides, iodides, cyanides, nitrates, acetates, acetylacetonates, hexafluoroacetylacetonates, tetrafluoroborates, perfluoroacetates or triflates, in particular of palladium, platinum, rhodium, ruthenium, osmium, iridium, cobalt, nickel or of copper.

Examples of the pre-complexes are:
cyclooctadienepalladium chloride, cyclooctadienepalladium iodide,
1,5-hexadienepalladium chloride, 1,5-hexadienepalladium iodide, bis-(dibenzylideneacetone)palladium, bis(acetonitrile)palladium(II)chloride, bis(acetonitrile)palladium(II)bromide, bis(benzonitrile)palladium(II)chloride, bis(benzonitrile)palladium(II)bromide, bis(benzonitrile)palladium(II)iodide, bis(allyl)palladium, bis(methallyl)palladium, allylpalladium chloride dimer, methallylpalladium chloride dimer, tetramethylethylenediaminepalladium dichloride, tetramethylethylenediaminepalladium dibromide, tetramethylethylenediaminepalladium diiodide, tetramethylethylenediaminepalladiumdimethyl,
cyclooctadieneplatinum chloride, cyclooctadieneplatinum iodide, 1,5-hexadieneplatinum chloride,
1,5-hexadieneplatinum iodide, bis(cyclooctadiene)platinum, potassium (ethylenetrichloroplatinate),
cyclooctadienerhodium(I)chloride dimer, norbornadienerhodium(I)chloride dimer,
1,5-hexadienerhodium(I)chloride dimer, tris(triphenylphosphane)rhodium(I)chloride,
hydridocarbonyltris(triphenylphosphane)rhodium(I)chloride,
bis(norbornadiene)rhodium(I)perchlorate, bis(norbornadiene)rhodium(I)tetrafluoroborate, bis(norbornadiene)rhodium(I)triflate, bis(acetonitrilecyclooctadiene)rhodium(I)perchlorate, bis(acetonitrilecyclooctadiene)rhodium(I)tetrafluoroborate, bis(acetonitrilecyclooctadiene)rhodium(I)triflate,
bis(acetonitrilecyclooctadiene)rhodium(I)perchlorate, bis(acetonitrilecyclooctadiene)rhodium(I)tetrafluoroborate, bis(acetonitrilecyclooctadiene)rhodium(I)triflate,
cyclopentadienerhodium(III)chloride dimer, pentamethylcyclopentadienerhodium(III)chloride dimer,
(cyclooctadiene)Ru(η³-allyl)₂, ((cyclooctadiene)Ru)₂(acetate)₄, ((cyclooctadiene)Ru)₂(trifluoroacetate)₄, RuCl₂(arene) dimer, tris(triphenylphosphane)ruthenium(II)chloride, cyclooctadieneruthenium(II)chloride, OsCl₂(arene) dimer, cyclooctadieneiridium(I)chloride diner, bis(cyclooctene)iridium(I)chloride diner,
bis(cyclooctadiene)nickel, (cyclododecatriene)nickel, tris(norbornene)nickel, nickeltetracarbonyl, nickel(II)acetylacetonate,
(arene)copper triflate, (arene)copper perchlorate, (arene)copper trifluoroacetate, cobaltcarbonyl.

The complex compounds based on one or more metals of the metallic elements and ligands of the general formula (I), in particular from the group consisting of Ru, Os, Co, Rh, Ir, Ni, Pd, Pt and Cu may already be catalysts or be used for the preparation of catalysts according to the invention based on one or more metals of the metallic elements, in particular from the group consisting of Ru, Os, Co, Rh, Ir, Ni, Pd, Pt and Cu.

All of these complex compounds are particularly suitable as a catalyst for asymmetric reactions.

Their use for asymmetric hydrogenation, hydroformylation, rearrangement, allylic alkylation, cyclopropanation, hydrosilylation, hydride transfer reactions, hydroboronations, hydrocyanations, hydrocarboxylations, aldol reactions or the Heck reaction is particularly preferred.

Their use in the asymmetric hydrogenation of e.g. C═C, C=0 or C═N bonds, in which they show high activities and selectivities, and hydroformylation is very particularly preferred. In particular, it has proved advantageous here that due to being easily and widely modifiable, the ligands of the general formula (I) can be matched sterically and electronically very well to the particular substrate and the catalytic reaction.

The use of the complexes or catalysts according to the invention for the hydrogenation of E/Z mixtures of prochiral N-acylated β-aminoacrylic acids or derivatives thereof is particularly preferred. Acetyl, formyl or urethane or carbamoyl protective groups can preferably be used here as the acyl group. Since both E and the Z derivatives of these hydrogenation substrates can be hydrogenated in similarly good enantiomer excesses, an E/Z mixture of prochiral N-acylated β-aminoacrylic acids or derivatives thereof can be hydrogenated with overall excellent enantiomer enrichments without prior separation. Reference is made to EP1225166 in respect of the reaction conditions to be applied. The catalysts mentioned here are employed in an equivalent manner.

In general, the β-amino acid precursors (acids or esters) are prepared in accordance with instructions from the literature. In the syntheses of the compounds, the general instructions of Zhang et al. (G. Zhu, Z. Chen, X. Zhang J. Org. Chem. 1999, 64, 6907-6910) and Noyori et al. (W. D. Lubell, M. Kitamura, R. Noyori Tetrahedron: Asymmetry 1991, 2, 543-554) as well as Melillo et al. (D. G. Melillo, R. D. Larsen, D. J. Mathre, W. F. Shukis, A. W. Wood, J. R. Colleluori J. Org. Chem. 1987 52, 5143-5150) can be used for guidance. Starting from the corresponding 3-ketocarboxylic acid esters, the desired prochiral enamides were obtained by reaction with ammonium acetate and subsequent acylation.

The hydrogenation products can be converted into the β-amino acids by measures known to the person skilled in the art (analogously to the α-amino acids).

The use of the ligands and complexes/catalysts in principle takes place in the nature and manner known to the person skilled in the art in the form of transfer hydrogenation (“Asymmetric transferhydrogenation of C═O and C═N bonds”, M. Wills et al. Tetrahedron: Asymmetry 1999, 10, 2045; “Asymmetric transferhydrogenation catalyzed by chiral ruthenium complexes” R. Noyori et al. Acc. Chem. Res. 1997, 30, 97; “Asymmetric catalysis in organic synthesis”, R. Noyori, John Wiley & Sons, New York, 1994, p. 123; “Transition metals for organic Synthesis” ed. M. Beller, C. Bolm, Wiley-VCH, Weinheim, 1998, vol. 2, p. 97; “Comprehensive Asymmetric Catalysis” ed.: Jacobsen, E. N.; Pfaltz, A.; Yamamoto, H., Springer-Verlag, 1999), but can also take place conventionally with elemental hydrogen. The process can accordingly be carried out by means of hydrogenation with hydrogen gas or by means of transfer hydrogenation.

In the case of enantioselective hydrogenation, a procedure is preferably followed in which the substrate to be hydrogenated and the complex/catalyst are dissolved in a solvent. Preferably, as indicated above, the catalyst is formed from a pre-catalyst in the presence of the chiral ligand by reaction or by prehydrogenation before the substrate is added. Hydrogenation is then carried out under a hydrogen pressure of 0.1 to 100 bar, preferably 0.5 to 10 bar.

The temperature during the hydrogenation should be chosen such that the reaction proceeds sufficiently rapidly at the desired enantiomer excesses, but side reactions are as far as possible avoided. The reaction is advantageously carried out at temperatures of from −20° C. to 100° C., preferably 0° C. to 50° C.

The ratio of substrate to catalyst is determined by economic aspects. The reaction should be carried out sufficiently rapidly at the lowest possible complex/catalyst concentration. However, a substrate/catalyst ratio of between 50,000:1 and 10:1, preferably 1,000:1 and 50:1, is preferably used.

The use of the ligands or complexes which have been polymer-enlarged in accordance with WO0384971 in catalytic processes which are carried out in a membrane reactor is advantageous. The continuous procedure which is possible in this apparatus, in addition to the batch and semi-continuous procedure, can be carried out here as desired in the cross-flow filtration mode (FIG. 2) or as dead-end filtration (FIG. 1).

Both process variants are described in principle in the prior art (Engineering Processes for Bioseparations, ed.: L. R. Weatherley, Heinemann, 1994, 135-165; Wandrey et al., Tetrahedron Asymmetry 1999, 10, 923-928).

For a complex/catalyst to appear suitable for use in a membrane reactor, it must meet the most diverse criteria. Thus, on the one hand it is to be noted that a correspondingly high retention capacity for the polymer-enlarged complex/catalyst must be present so that a satisfactory activity exists in the reactor over a desired period of time without the complex/catalyst having to be constantly topped up, which is a disadvantage in terms of industrial economics (DE19910691). The catalyst employed should furthermore have an appropriate tof (turnover frequency) in order to be able to convert the substrate into the product in economically reasonable periods of time.

In the context of the invention, polymer-enlarged complex/catalyst is understood as meaning the fact that one or more active units which cause chiral induction (ligands) are copolymerized in a form suitable for this with further monomers, or that these ligands are coupled by methods known to the person skilled in the art to a polymer which is already present. Forms of the units which are suitable for copolymerization are well-known to the person skilled in the art and can be chosen freely by him. Preferably, a procedure is followed here in which, depending on the nature of the copolymerization, the molecule in question is derivatized with groups which are capable of copolymerization, e.g. by coupling to acrylate/acylamide molecules in the case of copolymerization with (meth)acrylates. In this connection, reference is made in particular to EP 1120160 and polymer enlargements described there.

At the time of the invention, it was by no means obvious that the ligand systems disclosed here allow development of catalyst systems which can be employed under substantially more drastic conditions compared with the known system of the prior art and at the same time allow the advantageous properties and capabilities of the systems of the prior art to be preserved.

Methyl, ethyl, n-propyl, isopropyl, n-butyl, isobutyl, sec-butyl, tert-butyl, pentyl, hexyl, heptyl or octyl, including all their bond isomers, are to be regarded as (C₁-C₈)-alkyl radicals.

The radical (C₁-C₈)-alkoxy corresponds to the radical (C₁-C₈)-alkyl, with the proviso that this is bonded to the molecule via an oxygen atom.

(C₂-C₈)-Alkoxyalkyl means radicals in which the alkyl chain is interrupted by at least one oxygen function, where two oxygen atoms cannot be bonded to one another. The number of carbon atoms indicates the total number of carbon atoms contained in the radical.

A (C₃-C₅)-alkylene bridge is a carbon chain having three to five C atoms, wherein this chain is bonded to the molecule in question via two different C atoms.

The radicals just described can be mono- or polysubstituted by halogens and/or radicals containing N, O, P, S or Si atoms. These are, in particular, alkyl radicals of the abovementioned type which contain one or more of these heteroatoms in their chain or which are bonded to the molecule via one of these heteroatoms.

(C₃-C₈)-Cycloalkyl is understood as meaning cyclopropyl, cyclobutyl, cyclopentyl, cyclohexyl or cycloheptyl radicals etc. These can be substituted by one or more halogens and/or radicals containing N, O, P, S or Si atoms and/or contain N, O, P or S atoms in the ring, such as e.g. 1-, 2-, 3-, 4-piperidyl, 1-, 2-, 3-pyrrolidinyl, 2-, 3-tetrahydrofuryl or 2-, 3-, 4-morpholinyl.

A (C₃-C₈)-cycloalkyl-(C₁-C₈)-alkyl radical designates a cycloalkyl radical as described above which is bonded to the molecule via an alkyl radical as mentioned above.

In the context of the invention, (C₁-C₈)-acyloxy denotes an alkyl radical as defined above with max. 8 C atoms which is bonded to the molecule via a COO function.

In the context of the invention, (C₁-C₈)-acyl denotes an alkyl radical as defined above with max. 8 C atoms which is bonded to the molecule via a CO function.

A (C₆-C₁₈)-aryl radical is understood as meaning an aromatic radical having 6 to 18 C atoms. This includes, in particular, radicals such as phenyl, naphthyl, anthryl, phenanthryl and biphenyl radicals, or systems of the type described above fused to the molecule in question, such as e.g. indenyl systems which can optionally be substituted by (C₁-C₈)-alkyl, (C₁-C₈)-alkoxy, NR¹R², (C₁-C₈)-acyl or (C₁-C₈)-acyloxy.

A (C₇-C₁₉)-aralkyl radical is a (C₆-C₁₈)-aryl radical bonded to the molecule via a (C₁-C₈)-alkyl radical.

In the context of the invention, a (C₃-C₁₈)-heteroaryl radical designates a five-, six- or seven-membered aromatic ring system of 3 to 18 C atoms which contains heteroatoms, such as e.g. nitrogen, oxygen or sulfur, in the ring. Radicals such as 1-, 2-, 3-furyl, such as 1-, 2-, 3-pyrrolyl, 1-, 2-, 3-thienyl, 2-, 3-, 4-pyridyl, 2-, 3-, 4-, 5-, 6-, 7-indolyl, 3-, 4-, 5-pyrazolyl, 2-, 4-, 5-imidazolyl, acridinyl, quinolinyl, phenanthridinyl and 2-, 4-, 5-, 6-pyrimidinyl, in particular, are regarded as such heteroaromatics.

A (C₄-C₁₉)-heteroaralkyl is understood as meaning a heteroaromatic system corresponding to the (C₇-C₁₉)-aralkyl radical.

Possible halogens (Hal) are fluorine, chlorine, bromine and iodine.

PEG denotes polyethylene glycol.

A nucleofugic leaving group is substantially understood as meaning a halogen atom, in particular chlorine or bromine, or so-called pseudo-halides. Further leaving groups can be tosyl, triflate, nosylate and mesylate.

In the context of the invention, the term enantiomerically enriched or enantiomer excess is understood as meaning the content of an enantiomer in a mixture with its optical antipodes in a range of >50% and <100%. The ee value is calculated as follows:
([Enantiomer1]−[Enantiomer2])/([Enantiomer1]+[Enantiomer2])=ee value

In the context of the invention, the naming of the complexes and ligands according to the invention includes all the possible diastereomers, whereby the two optical antipodes of a particular diastereomer are also intended to be named.

With their configuration, the complexes and catalysts described here determine the optical induction in the product. It goes without saying that the catalysts employed in racemic form also deliver a racemic product. A subsequent cleavage of the racemate then delivers the enantiomerically enriched products again. However, this is registered in the general knowledge of the person skilled in the art.

N-Acyl groups are to be understood as meaning protective groups which are generally conventionally employed for protection of nitrogen atoms in amino acid chemistry. Such groups which are to be mentioned in particular are: formyl, acetyl, Moc, Eoc, phthalyl, Boc, Alloc, Z, Fmoc, etc.

The literature references cited in this specification are regarded as contained in the disclosure.

In the context of the invention, membrane reactor is understood as meaning any reaction vessel in which the catalyst of enlarged molecular weight is enclosed in a reactor, while low molecular weight substances are fed to the reactor or can leave it. The membrane here can be integrated directly into the reaction space or incorporated outside in a separate filtration module, in which the reaction solution flows continuously or intermittently through the filtration module and the retained product is recycled into the reactor. Suitable embodiments are described, inter alia, in WO98/22415 and in Wandrey et al. in Yearbook 1998, Verfahrenstechnik und Chemieingenieurwesen [Process Technology and Chemical Engineering], VDI p. 151 et seq.; Wandrey et al. in Applied Homogeneous Catalysis with Organometallic Compounds, vol. 2, VCH 1996, p. 832 et seq.; Kragl et al., Angew. Chem. 1996, 6, 684 et seq.

In the context of the invention, a polymer-enlarged ligand/complex is to be understood as meaning a ligand/complex in which the polymer enlarging the molecular weight is bonded covalently to the ligands.

### DESCRIPTIONS OF THE DRAWINGS

FIG. 1 shows a membrane reactor with dead-end filtration. The substrate 1 is transferred via a pump 2 into the reactor space 3, which contains a membrane 5. In the reactor space, which is operated with a stirrer, are the catalyst 4, the product 6 and unreacted substrate 1, in addition to the solvent. Low molecular weight 6 is chiefly filtered off via the membrane 5.

FIG. 2 shows a membrane reactor with cross-flow filtration. The substrate 7 is transferred here via the pump 8 into the stirred reactor space, in which are also solvent, catalyst 9 and product 14. A solvent flow which leads via a heat exchanger 12, which may be present, into the cross-flow filtration cell 15 is established via the pump 16. The low molecular weight product 14 is separated off here via the membrane 13. High molecular weight catalyst 9 is then passed back with the solvent flow, if appropriate again via a heat exchanger 12, if appropriate via the valve 11, into the reactor 10.

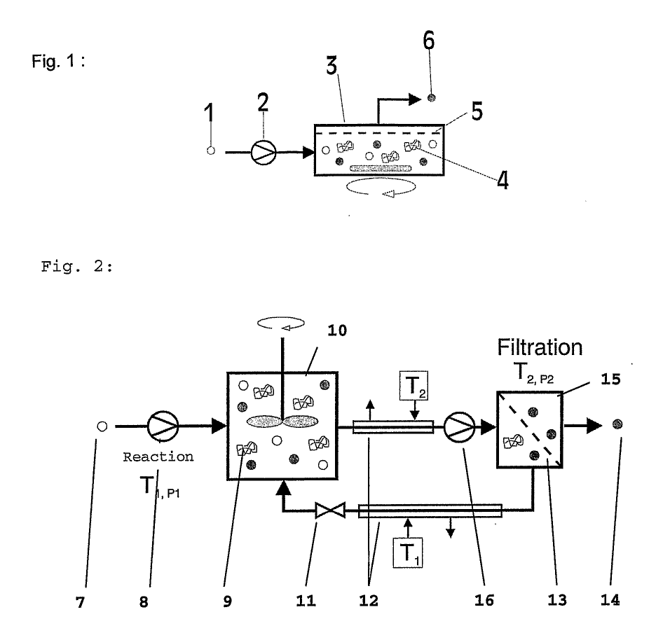

### EXAMPLES

### Preparation of 3,4-dichloro-thiophene-2,5-dione [S compound]

According to the Literature: O. Scherer, F. Kluge Chem. Ber. 99, 1966, 1973-1983

5 g tetrachlorothiophene are stirred with 13 ml HNO₃ for five minutes and the resulting brown solution is then, poured on to ice. The precipitate which has precipitated out is filtered off rapidly over a frit and recrystallized from cyclohexane. Slightly yellowish crystals are obtained in a yield of approx. 35%.

13C-NMR (CDCl₃): 143.5 (═C—Cl), 183.6 (C═O)

### Preparation of 4,5-dichloro-cyclopent-4-ene-1,2-dione [CH₂ compound]

According to the Literature: McBee et al. J. Chem. Soc. Am. 78, 1956, 489-491

0.85 g of the tetrachloro compound is stirred in 25 ml ethanol for 1.5 hours under reflux, while passing a stream of argon through the mixture. After cooling to room temperature and addition of 30 ml water, the mixture is concentrated on a rotary evaporate and a white precipitate precipitates out. Yield approx. 60%.

1H-NMR (acetone-d₆): 3.38 (CH₂);

13C-NMR (acetone-d₆): 43.1 (CH₂), 151.4 (═C—Cl, >C═, ═CCl₂), 189.7 (C═O);

Elemental analysis: C_{calc.} 36.40%, C_{found} 36.20%; H_{calc.} 1.22%, H_{found} 1.20%;

Mass spectrometry: M+=164

### Preparation of the Bisphospholane Compounds and Rh Complexes Thereof

0.75 mM (124 mg [CH₂ compound] or 137 mg [S compound]) in 2 ml THF are is initially introduced into the reactor at 0° C., and a solution of 285 mg (2 eq) trimethylsilylphospholane in 2 ml THF is slowly added via a cannula. The mixture is stirred overnight and the volatile constituents are removed in vacuo. The red residue is employed directly for formation of the complex. For this, the crude product was taken up in 3 ml CH₂Cl₂ and the mixture was slowly added dropwise at 0° C. to a solution of 305 mg [Rh(cod)₂]BF₄ in 2 ml CH₂Cl₂. After stirring for 2 hours at room temperature, the complex was precipitated with ether and, after filtration, washed twice with ether.

Yields approx. 50%.

S compound complex:

³¹P-NMR (CDCl₃): Crude product of the ligand:

+11.1 ppm;

¹H-NMR (CDCl₃): Complex

5.66 (2H, m, Hcod), 5.00 (2H, m, Hcod), 2.97 (2H, m, CH—P), 2.59-2.11 (18H, CH—P, CH₂); 1.51 (6H, dd, CH₃), 1.34 (6H, dd, CH₃); overlapped by the bischelate complex;

¹³C-NMR (CDCl₃): Complex

108.5 (m, CHcod), 94.6 (m, CHcod), 40.1 (m, CH—P), 38.5 (m, CH—P), 37.6 (CH₂), 35.2 (CH₂), 31.8 (CH₂), 28.6 (CH₂), 17.2 (m, CH₃), 13.9 (CH₃); C═O and C═C signals not visible;

³¹P-NMR (CDCl₃): Complex:

+65.3 ppm (d, J=151 Hz) to 90% and

+63.2 ppm (d, J=153 Hz) to 10%

CH₂ compound complex:

³¹P-NMR (CDCl₃): Crude product of the ligand:

+2.0 ppm;

¹H-NMR (CDCl₃): Complex

5.53 (2H, m, Hcod), 4.95 (2H, m, Hcod), 3.65 (2H, s, CH₂), 2.96 (2H, m, CH—P), 2.61-2.14 (16H, CH—P, CH₂); 1.45 (6H, dd, CH₃), 1.15 (6H, dd, CH₃);

¹³C-NMR (CDCl₃): Complex

192.9 (d, C═O), 174.8 (m, C═C); 107.4 (m, CHcod), 92.9 (m, CHcod), 50.8 (CH₂), 39.3 (m, CH—P), 37.8 (m, CH—P), 37.8 (CH₂), 35.5 (CH₂), 31.9 (CH₂), 28.7 (CH₂), 17.3 (m, CH₃), 13.8 (CH₃);

³¹P-NMR (CDCl₃): Complex:

+63.2 ppm (d, J=150 Hz)

General Hydrogenation Instructions

0.005 mmol pre-catalyst (S compound complex or CH₂ compound complex) and 0.5 mmol prochiral substrate are initially introduced into an appropriate hydrogenating vessel under an H₂ atmosphere and the mixture is temperature-controlled at 25° C. After addition of the appropriate solvent (7.5 ml methanol, tetrahydrofuran or methylene chloride) and pressure compensation (to atmospheric pressure), the hydrogenation is started by starting the stirring and beginning the automatic recording of the gas consumption under isobaric conditions. After the end of the uptake of gas, the experiment is ended and the conversion and selectivity of the hydrogenation are determined by means of gas chromatography.

Hydrogenation Results:

| | | S compound | CH2 compound |
|---|---|---|---|
| Catalyst | | complex | complex |
| Substrate | Solv. | % ee | % ee |
| Acetamidocinnamic acid | MeOH | 93.3 R; | 96.5 R |
| methyl ester | | 88.9 R (30% | |
| | THF | 94.5 R | 98.7 R |
| | CH₂Cl₂ | 80.9 R (8% con.) | 82.7 R |
| Itaconic acid dimethyl | MeOH | 6.2 S; racemate | 36.4 S |
| ester | THF | 13.0 S (50% | 64.9 S |
| | | con.) | |
| | CH₂Cl₂ | 95.9 S (40% | 98.9 S |
| | | con.) | |
| 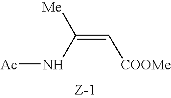 | MeOH THF CH₂Cl₂ | 0.8 R (70% con.) 17.6 R (5% con.) | 78.8 R 48.2 R 79.7 R (20% con.); |
| 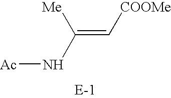 | MeOH THF CH₂Cl₂ | 4.5 R (20% con.) 47.1 R (32% con.) | 88.3 R 93.9 R 98.9 R |
| 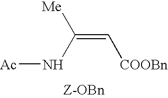 | MeOH THF CH₂Cl₂ | | 62.5 R 77.1 R 79.9 R (65% con.) |
| 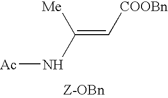 | MeOH THF CH₂Cl₂ | | 97.1 R 97.5 R 98.5 R (92% con.) |
| 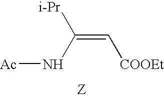 | MeOH THF CH₂Cl₂ | 2.7 S (10% con.) | 2.0 R 58.2 S 69.7 S (75% con.) |
| 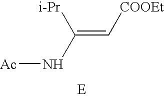 | MeOH THF CH₂Cl₂ | | 83.6 S 99.4 S 99.0 S |

1. Enantiomer-enriched bidentate organophosphorous ligands of the general formula (I) 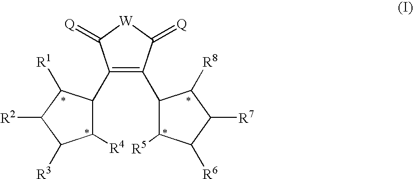
wherein
* denotes a stereogenic centre,
R¹, R⁴, R⁵, R⁸ independently of one another denote
(C₁-C₈)-alkyl, (C₁-C₈)-alkoxy, HO—(C₁-C₈)-alkyl,
(C₂-C₈)-alkoxyalkyl, (C₆-C₁₈)-aryl, (C₇-C₁₉)-aralkyl,
(C₃-C₁₈)-heteroaryl, (C₄-C₁₉)-heteroaralkyl,
(C₁-C₈)-alkyl-(C₆-C₁₈)-aryl,
(C₁-C₈)-alkyl-(C₃-C₁₈)-heteroaryl, (C₃-C₁₈)-cycloalkyl,
(C₁-C₈)-alkyl-(C₃-C₈)-cycloalkyl or
(C₃-C₈)-cycloalkyl-(C₁-C₈)-alkyl,
R², R³, R⁶, R⁷ independently of one another denote R¹ or H, wherein in each case adjacent radicals R¹ to R⁸ can be bonded to one another by a (C₃-C₅)-alkylene bridge, which can contain one or more double bonds or heteroatoms, such as N, O, P or S,
Q can be O, NR² or S,
W═S, CR²R³ or C—X, where X is chosen from the group consisting of CR²R³, O and NR².

2. Ligands according to claim 1,
characterized in that
R², R³, R⁶, R⁷ are (C₁-C₈)-alkoxy, (C₂-C₈)-alkoxyalkyl or H.

3. Ligands according to claim 1,
characterized in that
the compounds of the formula (I) have an enantiomer enrichment of >90%, preferably >95%.

4. Complex containing the ligands according to claim 1 and at least one transition metal.

5. Complex containing the ligands according to claim 1 with palladium platinum, rhodium, ruthenium, osmium, iridium, cobalt, nickel or copper.

6. Process for the preparation of the ligands according to claim 1,
characterized in that
a compound of the general formula (II) 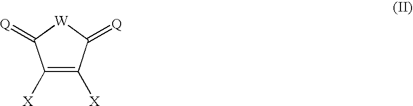
wherein
Q, W can assume the meaning given in claim 1,
X represents a nucleofugic leaving group,
is reacted with at least 2 equivalents of a compound of the general formula (III) 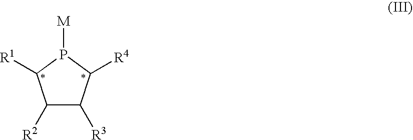
in which R¹ to R⁴ can assume the meaning given in claim 1 and
M can be a metal of the group consisting of Li, Na, K, Mg and Ca or is a trimethylsilyl group.

7. The complex compound of claim 4 as a catalyst for asymmetric reactions.

8. The complex compound claim 4 as a catalyst for asymmetric hydrogenation, hydroformylation, rearrangement, allylic alkylation, cyclopropanation, hydrosilylation, hydride transfer reactions, hydroboronations, hydrocyanations, hydrocarboxylations, aldol reactions or the Heck reaction.

9-15. (canceled)

16. The method for asymmetric hydrogenation and hydroformulation wherein the complex compound of claim 4 is used as a catalyst.

17. The catalyst for the hydrogenation of an E/Z mixture of prochiral N-acylated β amino-acrylic acid or derivatives thereof is a complex of claim 4.

18. The method of claim 16 characterized in that it is carried out by means of hydrogenation with hydrogen gas or by means of transfer hydrogenation.

19. The method according to claim 18 wherein the hydrogenation is carried out under a hydrogen pressure of 0.1 to 100 bar.

20. The method of claim 18 wherein the hydrogenation with hydrogen gas or hydrogen transfer reaction is carried out at temperatures of from −20° C. to 100° C.

21. The method of claim 18 wherein the ratio of substrate/catalyst is between 50,000:1 ands 10:1.

22. The method of claim 18 wherein the catalyst is carried out in a membrane reactor.
